(19) United States
(12) Patent Application Publication
(10) Pub. No.: US 2026/0233146 A1
(43) Pub. Date: Aug. 13, 2026

(54) PURIFICATION OF ELECTROLYTIC HYDROGEN

(71) Applicant: ARKEMA FRANCE, Puteaux (FR)

(72) Inventors: Cécile LUTZ, Lacq (FR); Ugo RAVON, Lacq (FR); Jean-Robert LASCOUMETTES, Lacq (FR)

(21) Appl. No.: 19/160,314

(22) PCT Filed: Feb. 28, 2024
(86) PCT No.: PCT/FR2025/050253

§ 371 Date: Aug. 27, 2025

(30) Foreign Application Priority Data
Feb. 28, 2023 (FR) FR2301830

(51) Int. Cl. B01D 53/04; B01J 20/18; B01J 20/32; C01B 3/56

(52) U.S. Cl. CPC B01D 53/04; B01J 20/186; B01J 20/3204; B01J 20/3236; C01B 3/56; B01D 2253/108; B01D 2253/1122; B01D 2253/25; B01D 2256/16; B01D 2257/102; B01D 2257/104; B01D 2257/80; C01B 2203/042; C01B 2203/0495

(57) ABSTRACT

The present invention relates to a process for purifying a hydrogen stream polluted with water, oxygen and possibly nitrogen, said process involving placing the hydrogen stream to be purified in contact with a zeolite-based adsorbent material comprising at least one metal chosen from the metals of columns 3 to 12 of the Periodic Table of the Elements, in zero-valent metal form, or in oxidized or reduced form, and recovering the purified hydrogen stream.

The invention also relates to the use of a zeolite-based adsorbent material comprising at least one metal from columns 3 to 12 of the Periodic Table of the Elements for the purification of hydrogen, and to the use of the hydrogen thus purified in industrial processes.

The invention relates to a process for purifying hydrogen from an electrolyzer and more specifically to a process for purifying hydrogen containing water and oxygen, and also possibly traces of nitrogen and/or traces of residual electrolytes, for instance potassium hydroxide.

The vast majority of the hydrogen produced industrially today is obtained by steam reforming. However, ecological constraints related to global warming have prompted scientists to reconsider water electrolysis for hydrogen production. One of the drawbacks of water electrolysis is that the hydrogen produced contains contaminants that are different from those produced by steam reforming, and notably contains oxygen, nitrogen and water.

Specifically, hydrogen produced by water electrolysis is often polluted with the oxygen coproduced, notably due to excessive oxygen permeation through the separating membrane(s) or dissolution of oxygen in the electrolyte. The water present in the hydrogen stream generally comes from gas entrainment, while nitrogen comes, for example, from the inertizing phases on start-up of the electrolyzer and from its dissolution in cold water, often under pressure, introduced into the electrolyzer.

All these contaminants must be eliminated because most, if not all, of the uses of hydrogen require a very pure gas, for example when hydrogen is used in the electrical or electronic field, notably in fuel cells. Specifically, in this type of use, contamination at and above 5 ppm of oxygen reduces the efficacy of the fuel cell. Moreover, the possible presence of nitrogen (for example if the water used is poorly degassed) may affect the functioning and power of a downstream fuel cell. It is thus crucial to have available very pure hydrogen.

The prior art already provides numerous solutions for obtaining very pure hydrogen. In particular, mention may be made of patent U.S. Pat. No. 11,420,869 B2, which describes the purification by PSA (abbreviation of “Pressure Swing Adsorption”) of a stream of hydrogen containing hydrocarbons and oxygen. The stream to be purified thus contains, for example, methane, C₂-C₃ hydrocarbons, and also traces of nitrogen, carbon monoxide and oxygen. These may be streams from a propane dehydrogenation unit, for example.

Typically, the removal of hydrocarbons is performed on active charcoal, the oxygen and carbon monoxide are removed by catalytic reaction on a copper-impregnated alumina layer, while the water and CO₂ produced by the catalytic reaction are removed by another layer of active charcoal.

US 2019/0247781 A proposes the specific removal of oxygen using a catalyst based on palladium (Pd), platinum (Pt) or copper (Cu) on alumina to reduce oxygen, prior to purification on PSA (known as the “DEOXO” unit).

Moreover, Ligen et al., “Energy efficient hydrogen drying and purification for fuel cell vehicles”, Int. J. Hydrogen Energy, (2020), 45, 10639 sqq., detail the use of a combination of DEOXO +VPSA (“Volume and Pressure Swing Adsorption”) units to purify a stream of hydrogen from an alkaline electrolyzer.

However, one of the drawbacks associated with the prior art techniques is that oxygen is only weakly, or even very weakly, adsorbed on most of the adsorbents conventionally used in PSA hydrogen techniques, namely active charcoals, aluminas, silica gels, and 5A or 13X molecular sieves. Thus, in order to remove oxygen from a hydrogen matrix, the solution currently adopted by the industry is to use a DEOXO unit which reduces oxygen to water, typically with a copper-impregnated alumina. The water is then removed in a PSA drying process. In conclusion, in order to purify a hydrogen matrix containing oxygen, no less than two units are required, which results in significant installation and energy costs.

US 2021/309517 A1 describes a process of purification by adsorption on a bed consisting of at least one layer of a reduction catalyst based on supported Cu, Pd or Pt, which is regenerated by countercurrent circulation of a hydrogen-rich gas free of oxygen via a PSA process or a TSA (Temperature Swing Adsorption) process. The preferred catalyst is an alumina impregnated with at least 10% by mass of copper. It is preferably used in a three-layer configuration: a first layer of adsorbent dries the stream (silica gel, activated alumina, 13X), a second layer (copper-impregnated alumina) removes oxygen by exothermic catalytic reaction (O₂+H₂←→H₂O), the third layer (silica gel, activated alumina, 13X, CaX, 5A) removes the water produced when the stream passes over the second layer and also optionally removes nitrogen.

This solution, consisting of a single treatment bed with several layers of materials (adsorbents and catalyst), is an improvement, but is somewhat complex and expensive due to the use of several materials and a catalyst based on alumina heavily charged with copper.

There is thus still a need for a hydrogen purification process that is readily industrializable, less expensive and easy to perform, notably a hydrogen purification process that is less expensive and easier to perform than with the techniques known today. Thus, one of the objects of the present invention is to provide a hydrogen purification process which overcomes the drawbacks encountered in the prior art, and notably to purify hydrogen in a simpler manner, and in particular to remove both the oxygen and water present as impurities in a hydrogen stream.

Another object of the present invention is to provide a hydrogen purification process allowing the simultaneous removal of the oxygen and water present as impurities in a hydrogen stream, but also nitrogen and other impurities such as traces of residual electrolytes, for instance potassium hydroxide, notably for hydrogen streams from an electrolyzer, also referred to as electrolytic hydrogen. Other objectives will emerge in the light of the following description of the present invention.

The Applicant has now discovered that it is possible to meet all or at least some of the objects disclosed above, and in particular to purify a hydrogen stream, notably an electrolytic hydrogen stream, by removing, or at least greatly reducing, the oxygen and water contents, and also, where appropriate, the contents of nitrogen and other traces of residual electrolytes, in a simple, effective and relatively inexpensive manner, and most particularly while overcoming all or some of the problems encountered in the prior art.

Unless otherwise indicated in the following disclosure of the invention, all the ranges of values and notably those identified by “between . . . and . . . ” or “from . . . to . . . ” are understood to be inclusive of the limits. All the percentages are mass percentages, unless otherwise indicated.

The present invention thus proposes an “all-in-one” process for purifying hydrogen by removing both oxygen and water using a single zeolite-based adsorbent material, the zeolite of which has undergone at least partial cationic exchange and/or impregnation with at least one metal from columns 3 to 12 of the Periodic Table of the Elements.

A subject of the present invention is, more specifically, a process for purifying a hydrogen stream containing water, oxygen and possibly nitrogen, comprising:
at least one step of placing the hydrogen stream to be purified in contact with a zeolite-based adsorbent material comprising at least one metal from columns 3 to 12 of the Periodic Table of the Elements, in zero-valent metal form, or in oxidized or reduced form, and
at least one purified hydrogen stream recovery step.

In one embodiment of the invention, the hydrogen to be purified comprises electrolytic hydrogen, i.e. hydrogen obtained by electrolysis of water. In a preferred embodiment, the hydrogen to be purified predominantly comprises hydrogen, i.e. from 60 mol % to 99.99 mol % of pure hydrogen, preferably from 80 mol % to 99.99 mol % of pure hydrogen, more preferably from 90 mol % to 99.99 mol % of pure hydrogen and more preferentially from 95 mol % to 99.99 mol % of pure hydrogen, typically from 96.50 mol % to 99.99 mol % of pure hydrogen. As indicated previously, the hydrogen to be purified comprises at least water and oxygen as impurities, and also possibly nitrogen.

The zeolite-based adsorbent material used in the present invention is a granular material comprising at least one zeolite exchanged and/or impregnated with one or more metals from columns 3 to 12 of the Periodic Table of the Elements, in zero-valent metal form, or in oxidized or reduced form.

The term “metals from columns 3 to 12 of the Periodic Table of the Elements” means transition metals (columns 3 to 11 of the Periodic Table of the Elements), including lanthanides and actinides, and also metals from column 12 of the Periodic Table of the Elements, and in particular those chosen from transition metals (columns 3 to 11 of the Periodic Table of the Elements), zinc and cerium, and more preferably from iron, cobalt, cerium, nickel, titanium, copper, zinc, palladium, silver and platinum, alone or as mixtures of two or more thereof.

According to a preferred embodiment, the metal is chosen from the metals of columns 8 to 12 of the Periodic Table of the Elements, and titanium and cerium, alone or as mixtures of two or more thereof. In yet another preferred embodiment, the metal is chosen from copper, iron and zinc, alone or as mixtures, and optionally with one or more metals chosen from palladium, silver and platinum. Among these metals, copper is most particularly preferred. Copper/palladium, copper/silver and copper/platinum mixtures are also preferred.

Needless to say, other metals can be used, but the preferred metals and metal mixtures listed above have proven to be most particularly effective and advantageous in terms of their efficacy/supply cost ratio.

The zeolite-based adsorbent material that may be used in the process of the invention consequently comprises at least one zeolite-based adsorbent material and at least one metal, as disclosed above. Said at least one metal may be present in said zeolite-based adsorbent material in the native form (or in metallic form, i.e. with zero valency, equal to 0) or oxidized form, or else in reduced form, adsorbed totally or at least partially on said at least one zeolite. The metal may also be present in ionic form in the zeolite-based adsorbent material, in which case it contributes totally or at least partly to the electronic neutrality of said zeolite-based adsorbent material.

The zeolite-based adsorbent material that may be used in the process of the invention thus comprises at least one metal, as just defined, said at least one metal being able to be provided, i.e. deposited and/or impregnated and/or included by ion exchange, in the zeolite structure, as explained later.

The provision can be achieved according to conventional methods well known to those skilled in the art and is generally and advantageously achieved by means of one or more aqueous, organic or hydro-organic saline solutions, at least one of which includes one or more metal salts, said saline solutions preferably being chosen from the nitrates, acetates, sulfates, and others, of said metals.

The total mass amount of metal provided in the zeolite structure is generally and usually between 0.1% and 9%, preferably between 0.5% and 8% by mass, more preferably between 1% and 6% by mass, limits included, relative to the total weight of the zeolite-based adsorbent material used in the process of the present invention. This mass content is measured by X-ray fluorescence (FluoX) analysis, as indicated later in the description.

According to a preferred embodiment, in the case where the metal(s) are at least partly or completely deposited or impregnated on the zeolite crystals, the particle size of the metal particles is between 1 nm and 250 nm, preferably between 5 nm and 250 nm, more preferably between 5 nm and 100 nm, even more preferably between 5 nm and 50 nm, for example from about 15 nm to 20 nm. This particle size is measured by observation with a Scanning Electron Microscope (SEM) fitted with a STEM (“Scanning Transmission Electron Microscopy”) detector.

As indicated previously, among the preferred metals, copper is preferably used, and in this case the copper content in the zeolite-based adsorbent material used in the process of the present invention is preferably, and usually, between 0.1% and 9% by mass, preferably between 0.5% and 8% by mass, more preferably between 1% and 6% by mass, limits included, relative to the total weight of said zeolite-based adsorbent material. This content is notably very much lower than that encountered in copper-containing zeolite-based adsorbent materials, also known as copper-doped zeolite-based adsorbents, and known from the prior art.

According to a preferred embodiment, the process of the invention is performed with a zeolite-based adsorbent material containing copper and at least one other metal, preferably at least one other metal chosen from palladium (Pd), platinum (Pt), nickel (Ni), iron (Fe), zinc (Zn), and mixtures thereof in all proportions. The content of at least one other metal is generally lower than the copper content, for example of the order of 20% by mass relative to the mass content of copper, preferably of the order of 10% by mass relative to the mass content of copper, and more generally between 0.1% and 20%, usually between 0.1% and 10% by mass relative to the mass content of copper. The content of at least one other metal may, however, in certain cases and when desired, be greater than or equal to the copper content, notably equal to or greater by 1% to 100%, advantageously by 5% to 70%, better still equal to or greater by 10% to 70% by mass relative to the copper content.

Said at least one zeolite present in the zeolite-based adsorbent material that may be used in the process of the present invention may be of any type well known to those skilled in the art and may be natural, artificial (modified natural zeolite) or synthetic (obtained by synthesis). Preferably, said at least one zeolite is chosen from LTA, FAU, RHO, MFI zeolites and also mixtures of two or more thereof. Most particularly preferred are zeolites chosen from FAU-type zeolites, MFI-type zeolites, and mixtures thereof in all proportions and with all Si/Al ratios. Advantageously, reference may be made to the book “Atlas of Zeolite Framework Types”, Elsevier, 5th edition (2001), for information regarding the various zeolite types listed above.

It should be understood that the zeolite-based adsorbent material that may be used in the process of the present invention may comprise one or more zeolite(s) of identical or different type(s), for example an X-type zeolite alone or together with an MFI-type zeolite, or an X-type zeolite with an Si/Al ratio of about 1.25, and an X-type zeolite with an Si/Al ratio of about 1, or else a Y-type zeolite alone or with an MFI-type zeolite, to mention just a few simple illustrative examples and without any intention of limiting the scope of the present invention. It would consequently not be outside the context of the invention if the zeolite were formed of a mixture of structures with different Si/Al mole ratios.

According to one embodiment of the invention, the Si/Al ratio of the zeolite, or else the apparent overall ratio of the zeolite mixture if there are several in the zeolite-based agglomerate material, may have any value between 1 and 100. According to a preferred aspect, this Si/Al ratio is between 1 and 80, more preferably between 1 and 50, advantageously between 1 and 20.

The zeolite-based adsorbent material that may be used in the process of the present invention may also comprise hierarchically porous homologs of the zeolites listed above. Hierarchically porous zeolites are well known to those skilled in the art and can be prepared, for example, according to the procedures described in patent applications WO 2015/019013 and WO 2015/028740, or else prepared by chemical, physical or physicochemical post-treatment of conventional zeolites, which are not hierarchically porous zeolites, also known as non-mesoporous zeolites.

The term “zeolite-based adsorbent material” means zeolite crystals or mixtures of crystals of different zeolites, optionally agglomerated with one or more agglomeration binders well known to those skilled in the art, for example chosen from aluminas, silicas and clays. Agglomeration may be performed before or after the operation(s) for providing metal(s).

According to a preferred aspect, the zeolite-based adsorbent material of the invention is in the form of an agglomerate, i.e. a material in which the crystals of zeolite(s) are agglomerated with the aid of an agglomeration binder, as is now perfectly known to those skilled in the art. The agglomeration binder may be of any type, but preferred for the purposes of the present invention is an agglomeration binder chosen from clays, aluminas, silicates, and mixtures of two or more thereof in any proportions, and preferably the agglomeration binder is chosen from clays, and more preferably from kaolinic clays, such as kaolin, dickite, halloysite, kaolinite, nacrite, and the like.

The binder ratio, i.e. the mass amount of agglomeration binder relative to the total weight of the zeolite-based adsorbent material, is within the ranges known to those skilled in the art, and is generally between 0.1% and 30%, preferably between 1% and 30%, more preferably between 5% and 30%, and advantageously between 10% and 30% by weight.

When agglomerating zeolite crystals with at least one agglomeration binder, it may also be advantageous or even desirable to add one or more additives or fillers well known to those skilled in the art, including, by way of illustrative and nonlimiting examples, additives well known to those skilled in the art, and notably those chosen from forming-aid additives, pore-forming agents, silica, carboxymethylcellulose and others, and mixtures of two or more thereof in any proportion, to mention only the main additives commonly used when agglomerating zeolite crystals with an agglomeration binder.

When the binder is a zeolitizable binder, for instance kaolin, kaolinite and the like, it can be totally or partially zeolitized, i.e. converted into zeolite, generally and usually under the action of a base, for instance a sodium hydroxide solution, as is well known to those skilled in the art.

The zeolite-based adsorbent materials that are suitable for use in the process of the present invention are generally and usually in the form of beads but can assume any other shape, for example needles, cylinders, hollow cylinders, discs, trilobes, quadrilobes, extrudates, crushed and in other forms.

The zeolite-based adsorbent material can be of any size and dimension, however a zeolite-based adsorbent material with a volume-mean diameter of between 0.1 mm and 10 mm, preferably between 0.1 mm and 5 mm, more preferably between 0.5 mm and 5 mm, advantageously between 1 mm and 5 mm, is preferred and usually used.

The zeolite-based adsorbent material that is suitable for use in the process of the invention is commercially available or can be obtained using conventional techniques well known to those skilled in the art, starting from operating procedures known from the literature or the internet, or else techniques that can be readily adapted from said known operating procedures.

In one embodiment, the zeolite-based adsorbent material can be readily prepared from zeolite-based adsorbents, based on conventional zeolite(s) and/or based on hierarchically porous zeolite(s), and comprising one or more alkali metal and/or alkaline-earth metal cations, in particular lithium, sodium, potassium, calcium, strontium or barium, and an agglomeration binder that is optionally totally or at least partially zeolitized, said zeolite-based adsorbent being subjected to an impregnation and/or ion exchange treatment with at least one metal as defined previously, generally in salt form, according to conventional techniques that are well known to those skilled in the art.

As a variant, the step of impregnation and/or ion exchange of at least one metal as defined previously may be performed directly on the zeolite crystals prior to agglomeration with a binder and forming into shape.

According to a preferred aspect, the process for preparing the zeolite-based adsorbent material that may be used in the context of the present invention includes at least the following steps:
a) one or more cationic exchange(s) and/or impregnation(s) of zeolite crystals with one or more saline solutions of at least one metal chosen from the metals of columns 8 to 12 of the Periodic Table of the Elements, as defined previously,
b) agglomeration with at least one agglomeration binder,
c) heat treatment (calcination) to harden said agglomeration binder(s),
d) optionally at least partial zeolitization of said agglomeration binder(s), and
e) recovery and optional activation, generally between 100° C. and 550° C., of said zeolite-based adsorbent material that may be used in the context of the present invention.

In the process described above, step a) may be performed one or more times before step b) and/or after step c) and/or d).

A baking step is generally performed, preferably between step b) and step d), at a temperature generally between 400° C. and 600° C., although this is not in any way mandatory. As a variant, and when a baking step is performed, it may be possible to perform step a) after this baking step, and before step d), whether or not a step a) has already been performed before step b).

According to a preferred embodiment of the process for preparing the zeolite-based adsorbent material that may be used in the process of the present invention, a step of forming said agglomerated material into shape is performed, according to any method well known to those skilled in the art This step of forming into shape may be performed during or after agglomeration step b) and may be followed by one or more cationic exchange and/or impregnation steps a).

The heat treatment step(s) described in the above process must not result in significant sintering of the metal atoms, which must remain as dispersed as possible in the zeolite(s). This point can be readily observed by scanning electron microscopy (SEM) or transmission electron microscopy (TEM). Sintering of metal atoms is in particular readily avoided, as is well known, by careful and rigorous control of the heat treatment temperatures and durations.

Such processes for preparing zeolite-based adsorbent materials exchanged and/or impregnated with one or more metals are well known to those skilled in the art, and reference may be made, for example and in a nonlimiting manner, to EP 1125635 for a precise description of the manner in which the zeolite-based adsorbent materials that may be used in the context of the process of the invention are prepared, or else to the document “Metal Sites in Zeolites: Synthesis, Characterization and Catalysis”, Q. Zhang et al., Chem. Rev. (2023), 123(9), 6039-6106.

More particularly, cationic exchanges can be performed according to any method well known to those skilled in the art, for example by placing a zeolite-based adsorbent material in contact with one or more, preferably aqueous, saline solutions, at least one of which includes one or more metal salts; the cationic exchange may be single or multiple, and when it is multiple, the successive exchanges may be performed with identical or different saline solutions, each exchange step possibly being preceded and/or followed by at least one washing and/or heat treatment step, said heat treatment possibly being an oxidizing or reducing treatment.

The impregnation operation may also be readily performed according to any method well known to those skilled in the art, whether wet or dry impregnation. The term “wet impregnation” means placing a zeolite-based adsorbent material in aqueous and/or organic suspension in contact with one or more, preferably aqueous, saline solutions, at least one of which includes one or more metal salts, the wet impregnation operation possibly being preceded and/or followed by at least one heat treatment step, said heat treatment possibly being an oxidizing or reducing treatment. The term “dry impregnation” means placing a zeolite-based adsorbent material in contact with one or more, preferably aqueous, saline solutions of the correct volume, at least one of which includes one or more metal salts, the dry impregnation operation possibly being preceded and/or followed by at least one heat treatment step, said heat treatment possibly being an oxidizing or reducing treatment.

The various steps listed above, cationic exchange and/or impregnation, may be performed one or more times and may be combined, for example a cationic exchange operation may be followed by a wet or dry impregnation operation, and may comprise a washing step after cationic exchange and optionally a heat treatment prior to the impregnation operation.

These different cationic exchange and impregnation operations lead to the presence, in the zeolite-based adsorbent material, of at least one metal in cationic form. Before use in the process of the present invention, and if necessary or desirable, a treatment with a reducing element, for example and advantageously under a stream of hydrogen gas, allows the valence of the metal(s) to be reduced, possibly down to valence 0.

Nonlimiting examples of zeolite-based adsorbent materials that may be used in the process of the invention are as follows:
sodium MFI (MFI-Na) zeolites or protonated MFI (MFI-H) zeolites with an Si/Al mole ratio of between 2 and 20, having a content of between 0.1% and 9% of at least one metal chosen from Pd, Pt, Ni, Ti, Co, Zn, Ce, Fe, Cu, Zn and Ag, and preferably containing at least copper and optionally at least one other metal chosen from Pd, Pt, Ni, Ti, Co, Zn, Ce, Fe, Zn and Ag, and preferably chosen from Pd, Pt and Ni,
sodium FAU (FAU-Na) zeolites or protonated FAU (FAU-H) zeolites with an Si/Al mole ratio of between 1.25 and 20, having a content of between 0.1% and 9% of at least one metal chosen from Pd, Pt, Ni, Ti, Co, Zn, Ce, Fe, Cu, Zn and Ag, and preferably containing at least copper and optionally at least one other metal chosen from Pd, Pt, Ni, Ti, Co, Zn, Ce, Fe, Zn and Ag, and preferably chosen from Pd, Pt and Ni,
sodium LTA (LTA-Na) zeolites or protonated LTA (LTA-H) zeolites with an Si/Al mole ratio equal to 1, having a content of between 0.1% and 9% of at least one metal chosen from Pd, Pt, Ni, Ti, Co, Zn, Ce, Fe, Cu, Zn and Ag, and preferably containing at least copper and optionally at least one other metal chosen from Pd, Pt, Ni, Ti, Co, Zn, Ce, Fe, Zn and Ag, and preferably chosen from Pd, Pt and Ni, and
RHO sodium (RHO-Na) zeolites or protonated RHO (RHO-H) zeolites with an Si/Al mole ratio of between 1 and 20, having a content of between 0.1% and 9% of at least one metal chosen from Pd, Pt, Ni, Ti, Co, Zn, Ce, Fe, Cu, Zn and Ag, and preferably containing at least copper and optionally at least one other metal chosen from Pd, Pt, Ni, Ti, Co, Zn, Ce, Fe, Zn and Ag, and preferably chosen from Pd, Pt and Ni.

According to a preferred embodiment, the zeolite-based adsorbent material used in the present invention is a granular material comprising at least one zeolite exchanged or impregnated with copper, and optionally one or more other metals in zero-valent metal form, or in oxidized or reduced form chosen from those in columns 3 to 12.

A most particularly preferred embodiment of the process of the invention uses a zeolite-based adsorbent material which is a granular material comprising at least one zeolite exchanged or impregnated with copper, or with copper mixed or alloyed with one or more metals chosen from palladium, platinum, iron and zinc.

According to yet another preferred embodiment, the process of the invention uses a zeolite-based adsorbent material which is a granular material comprising at least one Faujasite (FAU) type zeolite, preferably an FAU type zeolite with an Si/Al ratio of between 1 and 100, for example an FAU-X type zeolite or an FAU-Y type zeolite, comprising sodium, and also comprising copper, or copper mixed or alloyed with one or more metals chosen from palladium, platinum, iron and zinc, the metal(s) possibly being exchanged or impregnated in said zeolite-based adsorbent material.

According to another preferred embodiment, the process of the invention uses a zeolite-based adsorbent material which is a granular material comprising at least one Faujasite (FAU) type zeolite, preferably an FAU type zeolite with an Si/Al ratio of between 2 and 100, for example an FAU-Y type zeolite, comprising sodium, and also comprising copper, or copper mixed or alloyed with one or more metals chosen from palladium, platinum, iron and zinc, the metal(s) possibly being exchanged and/or impregnated in said zeolite-based adsorbent material.

According to yet another preferred embodiment, the process of the invention uses a zeolite-based adsorbent material which is a granular material comprising at least one MFI-type zeolite, preferably an MFI-type zeolite with an Si/Al ratio of between 10 and 100, comprising sodium, and also comprising copper, or copper mixed or alloyed with one or more metals chosen from palladium, platinum, iron and zinc, the metal(s) possibly being exchanged or impregnated in said zeolite-based adsorbent material.

In a preferred embodiment, examples of zeolite-based adsorbent materials that may be used in the process of the invention are:

### Protonated FAU

protonated FAU zeolites, with an Si/Al ratio of between 2 and 10, and a copper content of between 7% and 9% by weight,
protonated FAU zeolites, with an Si/Al ratio of between 2 and 10, and a copper content of between 4% and 7% by weight,
protonated FAU zeolites, with an Si/Al ratio of between 2 and 10, a copper content of between 2% and 4% by weight, and a palladium content of between 0.1% and 1% by weight,
protonated FAU zeolites, with an Si/Al ratio of between 2 and 10, a copper content of between 0.5% and 2% by weight, and a palladium content of between 0.1% and 1% by weight,
protonated FAU zeolites with an Si/Al ratio of between 2 and 10, a copper content of between 0.5% and 2% by weight and a platinum content of between 0.1% and 1% by weight,
protonated FAU zeolites with an Si/Al ratio of between 2 and 10, a copper content of between 0.5% and 2% by weight and a nickel content of between 0.1% and 5% by weight,
protonated FAU zeolites, with an Si/Al ratio of between 2 and 10, a copper content of between 0.5% and 2% by weight, and an iron content of between 0.1% and 5% by weight,
protonated FAU zeolites with an Si/Al ratio of between 2 and 10, a copper content of between 0.5% and 2% by weight and a cobalt content of between 0.1% and 1% by weight,
protonated FAU zeolites with an Si/Al ratio of between 2 and 10, a copper content of between 0.5% and 2% by weight and a zinc content of between 0.1% and 5% by weight,
protonated FAU zeolites, with an Si/Al ratio of between 2 and 10, a copper content of between 0.5% and 2% by weight, and a titanium content of between 0.1% and 5% by weight,

### Sodium FAU

sodium FAU zeolites, with an Si/Al ratio of between 2 and 10, and a copper content of between 7% and 9% by weight,
sodium FAU zeolites, with an Si/Al ratio of between 2 and 10, and a copper content of between 4% and 7% by weight,
sodium FAU zeolites, with an Si/Al ratio of between 2 and 10, a copper content of between 2% and 4% by weight, and a palladium content of between 0.1% and 1% by weight,
sodium FAU zeolites, with an Si/Al ratio of between 2 and 10, a copper content of between 0.5% and 2% by weight, and a palladium content of between 0.1% and 1% by weight,
sodium FAU zeolites with an Si/Al ratio of between 2 and 10, a copper content of between 0.5% and 2% by weight and a platinum content of between 0.1% and 1% by weight,
sodium FAU zeolites with an Si/Al ratio of between 2 and 10, a copper content of between 0.5% and 2% by weight and a nickel content of between 0.1% and 5% by weight,
sodium FAU zeolites, with an Si/Al ratio of between 2 and 10, a copper content of between 0.5% and 2% by weight, and an iron content of between 0.1% and 5% by weight,
sodium FAU zeolites with an Si/Al ratio of between 2 and 10, a copper content of between 0.5% and 2% by weight and a cobalt content of between 0.1% and 1% by weight,
sodium FAU zeolites with an Si/Al ratio of between 2 and 10, a copper content of between 0.5% and 2% by weight and a zinc content of between 0.1% and 5% by weight,
sodium FAU zeolites, with an Si/Al ratio of between 2 and 10, a copper content of between 0.5% and 2% by weight, and a titanium content of between 0.1% and 5% by weight,

### Protonated MFI

protonated MFI zeolites, with an Si/Al ratio of between 10 and 20, and a copper content of between 7% and 9% by weight,
protonated MFI zeolites, with an Si/Al ratio of between 10 and 20, and a copper content of between 4% and 7% by weight,
protonated MFI zeolites, with an Si/Al ratio of between 10 and 20, a copper content of between 2% and 4% by weight, and a palladium content of between 0.1% and 1% by weight,
protonated MFI zeolites, with an Si/Al ratio of between 10 and 20, a copper content of between 0.5% and 2% by weight, and a palladium content of between 0.1% and 1% by weight,
protonated MFI zeolites with an Si/Al ratio of between 10 and 20, a copper content of between 0.5% and 2% by weight and a platinum content of between 0.1% and 1% by weight,
protonated MFI zeolites with an Si/Al ratio of between 10 and 20, a copper content of between 0.5% and 2% by weight and a nickel content of between 0.1% and 5% by weight,
protonated MFI zeolites, with an Si/Al ratio of between 10 and 20, a copper content of between 0.5% and 2% by weight, and an iron content of between 0.1% and 5% by weight,
protonated MFI zeolites with an Si/Al ratio of between 10 and 20, a copper content of between 0.5% and 2% by weight and a cobalt content of between 0.1% and 1% by weight,
protonated MFI zeolites with an Si/Al ratio of between 10 and 20, a copper content of between 0.5% and 2% by weight and a zinc content of between 0.1% and 5% by weight,
protonated MFI zeolites, with an Si/Al ratio of between 10 and 20, a copper content of between 0.5% and 2% by weight, and a titanium content of between 0.1% and 5% by weight,

### Sodium MFI

sodium MFI zeolites, with an Si/Al ratio of between 10 and 20, and a copper content of between 7% and 9% by weight,
sodium MFI zeolites, with an Si/Al ratio of between 10 and 20, and a copper content of between 4% and 7% by weight,
sodium MFI zeolites, with an Si/Al ratio of between 10 and 20, a copper content of between 2% and 4% by weight, and a palladium content of between 0.1% and 1% by weight,
sodium MFI zeolites, with an Si/Al ratio of between 10 and 20, a copper content of between 0.5% and 2% by weight, and a palladium content of between 0.1% and 1% by weight,
sodium MFI zeolites with an Si/Al ratio of between 10 and 20, a copper content of between 0.5% and 2% by weight and a platinum content of between 0.1% and 1% by weight,
sodium MFI zeolites with an Si/Al ratio of between 10 and 20, a copper content of between 0.5% and 2% by weight and a nickel content of between 0.1% and 5% by weight,
sodium MFI zeolites, with an Si/Al ratio of between 10 and 20, a copper content of between 0.5% and 2% by weight, and an iron content of between 0.1% and 5% by weight,
sodium MFI zeolites with an Si/Al ratio of between 10 and 20, a copper content of between 0.5% and 2% by weight and a cobalt content of between 0.1% and 1% by weight,
sodium MFI zeolites with an Si/Al ratio of between 10 and 20, a copper content of between 0.5% and 2% by weight and a zinc content of between 0.1% and 5% by weight,
sodium MFI zeolites, with an Si/Al ratio of between 10 and 20, a copper content of between 0.5% and 2% by weight, and a titanium content of between 0.1% and 5% by weight.

As indicated previously, the present invention relates to the process for purifying a stream of hydrogen, in particular a stream of electrolytic hydrogen, containing, as impurities to be removed, oxygen and water, and possibly nitrogen and possibly other impurities inherent in the hydrogen synthesis process, in particular an electrolytic hydrogen synthesis process.

As indicated previously, the process of the invention is an “all-in-one” hydrogen purification process, by removing both oxygen and water, present as impurities in a stream of hydrogen, more specifically a stream of hydrogen comprising or consisting of electrolytic hydrogen.

The term “all-in-one” process means that passage over the zeolite-based adsorbent material allows simultaneous (i.e. concomitant) at least partial, or even total (content below the detection threshold) elimination of the oxygen and water present in the hydrogen stream within the same temperature range. It is well known to those skilled in the art that zeolites must operate at high temperatures to eliminate oxygen, and that at high temperatures zeolites adsorb little or no water, and on the contrary tend to desorb water. The “all-in-one” process of the present invention thus has the great advantage of eliminating both oxygen and water, and possibly other impurities, from the stream of hydrogen, while dispensing with steps for changing temperature ranges, thus facilitating the industrial process in terms of time, energy expenditure and productivity. It may thus be considered that the process of the present invention allows the purification of streams of hydrogen without external energy supply, for example without external supply of heat.

Thus, the purification process of the present invention can be performed according to any method well known to those skilled in the art of gas purification, and more specifically by adsorption of impurities on a zeolite-based adsorbent material as defined previously. For example, the adsorption process according to the present invention may be chosen from pressure and/or temperature swing processes, typically PSA (“Pressure Swing Adsorption”), PVSA (“Pressure Vacuum Swing Adsorption”, with recourse to sub-atmospheric pressure desorption), TSA (“Temperature Swing Adsorption”), PTSA (“Pressure Temperature Swing Adsorption”), PVTSA (“Pressure Vacuum Temperature Swing Adsorption”, with recourse to sub-atmospheric pressure desorption).

The fluid to be purified (hydrogen to be purified) predominantly contains hydrogen, as indicated previously, and also water, oxygen and possibly nitrogen. The water content is generally between 20 ppmv and 1.5 mol %, preferably 50 ppmv and 1.5 mol %, more preferably between 100 ppmv and 1.5 mol %, advantageously between 200 ppmv and 1.5 mol %. The oxygen content in the stream is generally between 5 ppmv and 1 mol %, preferably between 5 ppmv and 5000 ppmv, more preferably between 5 ppmv and 3000 ppmv, better still between 5 ppmv and 1000 ppmv. The nitrogen content is between 0 and 1 mol %, generally between 10 ppmv and 1 mol %.

The process according to the present invention can be performed according to any conventional gas separation method, for example by passing over one or more columns (also referred to as “adsorber(s)” or more simply as “reactor(s)”) comprising at least one bed of zeolite-based adsorbent material as just defined. According to one embodiment, the process of the invention is performed with at least two adsorbers, notably when working in a continuous stream, via techniques well known to those skilled in the art.

Thus, the fluid to be purified is placed in contact with the zeolite-based adsorbent material at a pressure generally between 0.5 MPa and 5 MPa, preferably between 0.9 MPa and 5 MPa, more preferably between 1.5 MPa and 5 MPa, and at a temperature between 10° C. and 100° C., preferably between 15° C. and 90° C., advantageously between 20° C. and 60° C., typically between 25° C. and 55° C.

In a preferred embodiment, after the adsorption phase, the bed of zeolite-based adsorbent material is regenerated, i.e. desorbed either by pressure reduction and countercurrent discharge (PSA and VPSA processes), or by temperature reduction (TSA process), optionally combined with pressure reduction and countercurrent discharge (PVTSA process).

In the case of the PSA and VPSA processes, the desorption pressure is generally between 0.1 MPa and 1 MPa on the one hand, and 500 Pa and 95 kPa on the other, respectively. As a general rule, and for obvious reasons of ease of performance of the process and energy savings, the desorption temperature is close to the adsorption temperature, in other words, no intentional temperature change is generally made.

According to yet another preferred embodiment of the invention, a purge phase may be performed at the end of the desorption phase, typically by counter-current reintroduction of a fraction of the purified gas, typically less than 20% of the flow produced by an adsorber.

It should also be understood that the process of the present invention may also comprise one or more pressure equalization phases between any different adsorbers. The pressure equalization phase(s) may advantageously be performed between the adsorption and desorption phases, according to techniques that are also well known to those skilled in the art. The advantage of providing one or more pressure equalization phases is notably to minimize the loss of hydrogen in the process as a whole.

According to yet another variant, it may also be envisaged to recycle the gas collected during desorption, as is customary with hydrogen PSAs.

In the case of the TSA and PVTSA processes, a fraction of the purified gas (typically less than 20% of the flow produced by the adsorber) is heated to a temperature of between 40° C. and 250° C., then injected countercurrent-wise onto the adsorber, possibly at a reduced pressure relative to the adsorption phase (PVTSA), i.e. between 1 kPa and 3 MPa. As with PSA and VPSA, different pressure equalization and purge configurations may be envisaged.

In the process of the present invention, the adsorption and desorption phases follow one another in a cyclic manner. The process may optionally include a cooling system integrated into the adsorber, in order to avoid or at least minimize excessive heating of the adsorbent bed, which would inhibit water adsorption by the granular zeolite-based adsorbent material, as indicated previously. The process may also comprise a step of drying the gas stream, before and/or after passing over the zeolite-based adsorbent material comprising at least one metal according to the invention.

The fact of being able to dry, i.e. adsorb the water present or formed on the same material, will allow simplification of processes downstream of the electrolyzers while at the same time producing hydrogen of the required quality. By virtue of the implementation of the process of the invention, the DEOXO unit will notably no longer be necessary.

The process of the invention thus has many advantages, and most particularly that of being able both to reduce the dissolved oxygen in the stream of hydrogen and to adsorb any water already present in the stream of hydrogen, as well as the water formed by reduction of the dissolved oxygen. The process of the invention thus makes it possible to readily obtain, on an industrial scale, streams of hydrogen and notably streams of electrolytic hydrogen, comprising less than 5 ppmv of oxygen, and less than 1 ppmv of water, and more specifically a stream of hydrogen with a purity of greater than 99.97% even more specifically greater than 99.98% by volume and better still greater than 99.99% by volume. These percentages are calculated from measurements of residual impurity amounts. The impurity amounts are determined using an ionization mass spectrometer as indicated below.

According to another aspect of the invention, said invention relates to a purified stream of hydrogen obtained according to the process described previously, and to its use as a fuel, as an industrial reagent, in the electrical and electronic fields, and notably in fuel cells, but also to feed liquid organic hydrogen carrier (LOHC) cycles, such as toluene (methylcyclohexane) or other aromatic hydrocarbons, such as benzyltoluene or dibenzyltoluene (see, for example, international patent applications WO 2014/082801 and WO 2021/176170), to mention but a few known applications, and more generally for syntheses in the chemical, pharmaceutical and petrochemical industries.

According to another aspect, the invention relates to the use of zeolite-based adsorbent material as defined previously for the purification of a stream of hydrogen, and in particular for the purification of electrolytic hydrogen.

According to yet another aspect, the invention relates to a process for the preparation of high-purity hydrogen, comprising at least the following steps:
1) electrolysis of an aqueous solution predominantly comprising hydrogen oxide to generate a stream of hydrogen and a stream of oxygen,
2) recovery of the stream of hydrogen from electrolysis step 1),
3) purification of the stream of hydrogen recovered in step 2) by passage over a zeolite-based adsorbent material, as defined previously, and
4) recovery of high-purity hydrogen.

It should be understood that the process for preparing high-purity hydrogen according to the invention comprises an electrolysis step 1) which may be performed in the conventional manner well known to those skilled in the art.

This process thus allows the production of very high purity hydrogen in an efficient and economical manner, and in particular more economically than today's known synthetic processes for preparing hydrogen by electrolysis of water.

### Analytical Techniques

### Si/Al Mole Ratio and Degree of Exchange

Measurement of the Si/Al mole ratio and the degree of exchange is performed via any chemical analysis technique known to those skilled in the art. Among these techniques, mention may be made of the technique of chemical analysis by x-ray fluorescence as described in the standard NF EN ISO 12677:2011 on a wavelength-dispersive spectrometer (WDXRF), for example the Tiger S8 machine from the company Bruker.

X-ray fluorescence is a spectral technique that exploits the photoluminescence of atoms in the X-ray range so as to establish the elemental composition of a sample. Excitation of the atoms, generally with an X-ray beam or by electron bombardment, generates specific radiations after return to the ground state of the atom. The X-ray fluorescence spectrum has the advantage of depending very little on the chemical combination of the element, which offers a precise determination, both quantitatively and qualitatively. After calibrating for each oxide, a measurement uncertainty of less than 0.4% by weight is conventionally obtained.

These elemental chemical analyses make it possible to check the Si/Al mole ratio of the starting zeolite, the content of deposited metal(s), and also the quality of the ion exchange. In the description of the present invention, the measurement uncertainty of the Si/Al mole ratio is +5%. The quality of the ion exchange is linked to the number of moles of sodium oxide Na₂O remaining in the agglomerated zeolite-based adsorbent after exchange. It should be noted that the contents of the various oxides are given as weight percentages relative to the total weight of the anhydrous zeolite-based adsorbent material.

The Si/Al mole ratio of the zeolite present in the zeolite-based adsorbent material is measured by solid-state silicon nuclear magnetic resonance (NMR) spectroscopy. In the description of the present invention, the measurement uncertainty of the Si/Al mole ratio is ±5%.

### Metal Content

The amount of metal present in the zeolite-based adsorbent material is also obtained from X-ray fluorescence analysis, as indicated above, and is expressed as mass percentages of metal.

### Particle Size of the Metal Particles

The number-average diameter of the metal particles contained in the zeolite-based adsorbent material is estimated by observation using a scanning electron microscope (SEM).

In order to estimate the size of the metal particles in the samples, a set of images is acquired at a magnification of at least 5000. The diameter of at least 200 particles is then measured using dedicated software, for example the Smile View software published by LoGraMi. The precision is of the order of 3%. Measurement of the histogram formed from said diameter measurements simultaneously allows determination of the standard deviation o of its distribution.

### Zeolite-Based Adsorbent Particle Size

The volume-average diameter of the zeolite-based adsorbents is determined by analysis of the particle size distribution of a sample of agglomerates by imaging according to the standard ISO 13322-2:2006, using a conveyor belt for passing the sample in front of the objective lens of the camera.

The volume-average diameter is subsequently calculated from the particle size distribution by applying the standard ISO 9276-2:2001. In the present document, the term “volume-average diameter” or “size” is used for the zeolite-based agglomerates. The accuracy is about 0.01 mm for the size range of agglomerates of the invention.

Qualitative analysis by X-ray diffraction The purity of the zeolites in the zeolite-based adsorbent materials is evaluated by X-ray diffraction analysis, known to those skilled in the art by the acronym XRD. This identification is performed on a Bruker brand XRD machine.

This analysis makes it possible to identify the various zeolites present in the adsorbent material, since each zeolite structure has a unique diffraction pattern defined by the positions of the diffraction peaks and by their relative intensities.

Before measurement, the zeolite-based materials are ground and then spread out and smoothed out on a sample holder by simple mechanical compression.

The conditions under which the diffraction pattern is acquired on the Bruker D5000 instrument are as follows:
Cu tube used at 40 kV-30 mA;
slit size (divergent, scattering and analysis slits)=0.6 mm;
filter: Ni;
sample device rotating at: 15 rpm;
measuring range: 3°<2θ<50°;
step: 0.02°;
counting time per step: 2 seconds.

The diffraction pattern obtained is interpreted using the EVA software with identification of the zeolites with the aid of the ICDD PDF-2 database, 2011 release.

Microcrystallinity by Dubinin volume The Dubinin volume (or micropore volume Vₘᵢ) is determined in a conventional manner well known to those skilled in the art, notably from measurement of the adsorption isotherm of a gas at its liquefaction temperature, for example nitrogen, argon, oxygen, and the like. Preference is given to using nitrogen. Prior to said adsorption measurement, the zeolite crystals of the invention are degassed under reduced pressure (pressure <6.7×10⁻⁴ Pa) at between 300° C. and 450° C. for a period in the range from 9 hours to 16 hours. For example, for an MFI-or FAU-type zeolite, the nitrogen adsorption isotherm at 77 K is then measured on a Micromeritics ASAP 2020 instrument, taking at least 35 measurement points at relative pressures having a P/Po ratio of between 0.002 and 1. The micropore volume is determined according to the Dubinin-Raduskevitch equation from the isotherm obtained, by applying the standard ISO 15901-3:2007. The micropore volume thus evaluated is expressed in cm³ of liquid adsorbent per gram of anhydrous adsorbent. The measurement uncertainty is ±0.003cm³ ·g⁻¹.

### Example According to the Invention

A stream of hydrogen is recovered from an electrolyzer at a temperature of 50° C. The stream of hydrogen is pressurized to 0.8 MPa. The stream of hydrogen contains 3000 ppmv of oxygen and 1000 ppmv of water.

The stream of electrolytic hydrogen to be purified is introduced into a column containing 1 liter of zeolite-based adsorbent material. The contact time between the stream and said zeolite-based adsorbent material is set at 10 seconds. The zeolite-based adsorbent material is formed of 1 mm-diameter beads obtained by agglomeration, with 20% by weight of binder, of H-MFI (protonated MFI) zeolite crystals, with an Si/Al ratio equal to 12.5, a copper content of 4% by weight, and a palladium content of 0.2% by weight.

The purified stream of hydrogen recovered at the column outlet is analyzed using an ionization mass spectrometer. The oxygen content is confirmed by measurement using a galvanic cell from the company GMACX, and the residual water content is confirmed using a hygrometric probe from the company Panametrics. The hydrogen thus purified contains 2 ppmv of oxygen and 0.3 ppmv of water.

1. A process for purifying a stream of hydrogen containing water, oxygen and possibly nitrogen, comprising:
at least one step of placing the hydrogen stream to be purified in contact with a zeolite-based adsorbent material comprising at least one metal from columns 3 to 12 of the Periodic Table of the Elements, in zero-valent metal form, or in oxidized or reduced form, and
at least one purified hydrogen stream recovery step.

2. The process as claimed in claim 1, in which the hydrogen to be purified comprises electrolytic hydrogen.

3. The process as claimed in claim 1, in which the hydrogen to be purified comprises from 60 mol % to 99.99 mol % of pure hydrogen.

4. The process of claim 1, in which said at least one metal is chosen from the metals of columns 3 to 12 of the Periodic Table of the Elements, including the lanthanides and actinides, alone or as mixtures of two or more thereof.

5. The process of claim 1, in which the zeolite-based adsorbent material comprises at least one zeolite chosen from LTA, FAU, RHO and MFI zeolites and also mixtures of two or more thereof, and preferably chosen from FAU-type zeolites, MFI-type zeolites, and mixtures thereof in all proportions and with all Si/Al ratios.

6. The process of claim 1, in which the zeolite-based adsorbent material is a granular material comprising at least one zeolite exchanged or impregnated with copper, and optionally one or more other metals in zero-valent metal form, or in oxidized or reduced form chosen from those in columns 3 to 12.

7. The process of claim 1, in which the hydrogen stream to be purified is placed in contact with the zeolite-based adsorbent material at a pressure of between 0.5 MPa and 5 MPa, and at a temperature of between 10° C. and 100° C.

8. Use of a zeolite-based adsorbent material comprising at least one metal chosen from the metals of columns 3 to 12 of the Periodic Table of the Elements, including lanthanides and actinides, preferably chosen from iron, cobalt, cerium, nickel, titanium, copper, zinc, palladium, silver and platinum, alone or as mixtures of two or more thereof, for the purification of a stream of hydrogen, and in particular for the purification of electrolytic hydrogen.

9. Use of a purified stream of hydrogen obtained according to the process of claim 1, as a fuel, as an industrial reagent, in the electrical and electronic fields, in fuel cells, for feeding liquid organic hydrogen carrier (LOHC) cycles, and for syntheses in the chemical, pharmaceutical and petrochemical industries.
